(19) United States
(12) Patent Application Publication
(10) Pub. No.: US 2009/0200361 A1
(43) Pub. Date: Aug. 13, 2009

(54) Method for joining components using a brazing technique

(75) Inventors: Ulrich Knott, Muenchen (DE); Walter Gieg, Eichenau (DE); Anton Reichart, Eichenau (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/310,859

(22) PCT Filed: Sep. 5, 2007
(86) PCT No.: PCT/DE2007/001593

§ 371 Date: Mar. 10, 2009

(51) Int. Cl. B23K 1/20; B23K 11/11

(52) U.S. Cl. 228/175

(57) ABSTRACT

A method for joining components using a brazing technique, namely relatively thin-walled components, in particular sheet-metal panels, which are not inherently stable and thus are susceptible to deformation, comprising at least the following steps:
a) preparing at least two planar and relatively thin-walled components to be joined together, and a brazing foil;
b) placing the brazing foil between the components to be joined together;
c) fixing in position the components to be joined together by tack welding in such a way that a tack welding of the components, between which the brazing foil is placed, is carried out at at least one position that is spaced apart from an edge of the components;
d) joining the fixed-in-position components by brazing.

Priority is claimed to German Patent Application DE 10 2006 042 757.2. filed Sep. 12, 2006 through international application PCT/DE2007/001593, filed Sep. 5, 2007, the entire disclosures of which are hereby incorporated by reference herein.

The present invention relates to a method for joining components using a brazing technique.

### BACKGROUND OF THE INVENTION

To join components over a flat surface area using a brazing technique, it is already a known, standard practice to braze components together using a brazing foil, the brazing foil being positioned between the components to be joined together. To ensure a precise positioning of the components to be joined together during the process of joining the same using a brazing technique, it is also a known, standard practice to join the components together at the edges thereof, preferably to weld them together at the edges thereof. This makes it possible to ensure a precise alignment of the components when joining the same using a brazing technique, when working with relatively thick-walled components which are inherently stable and thus not susceptible to deformation.

However, if the intention is to braze together relatively thin-walled components, which are not inherently stable and are thus susceptible to deformation, over a flat surface area, then the standard, known procedure for joining components using a brazing technique is not suited since the relatively thin-walled components can become deformed during the brazing operation, so that they no longer retain their mutual alignment. This degrades the quality of the brazed joint.

### SUMMARY OF THE INVENTION

Against this background, an object of the present invention is to devise a novel method for brazing components using a brazing technique that is suited for joining relatively thin-walled components, in particular sheet-metal panels, which are not inherently stable and are thus susceptible to deformation.

The method according to the present invention includes at least the following steps:
a) preparing at least two planar and relatively thin-walled components to be joined together, and a brazing foil;
b) placing the brazing foil between the components to be joined together;
c) fixing in position the components to be joined together by tack welding in such a way that a tack welding of the components, between which the brazing foil is placed, is carried out at at least one position that is spaced apart from an edge of the components;
d) joining the fixed-in-position components by brazing.

Even when working with relatively thin-walled components, which are not inherently stable and are thus susceptible to deformation, the method according to the present invention makes possible a high-quality brazed joint over a flat surface area. Thus, the method according to the present invention makes it possible to reliably avoid a deformation of the components during the brazing process.

### BRIEF DESCRIPTION OF THE DRAWINGS

Preferred embodiments of the present invention are derived from the dependent claims and from the following description. The present invention is described in greater detail in the following on the basis of exemplary embodiments, without being limited thereto. Reference is made to the drawing, whose:

FIG. 1: shows a schematized cut-away portion of two components to be joined together, together with a brazing foil disposed therebetween;

FIG. 2: shows the cut-way portion from FIG. 1, the components being fixed in position relative to one another by a tack welding.

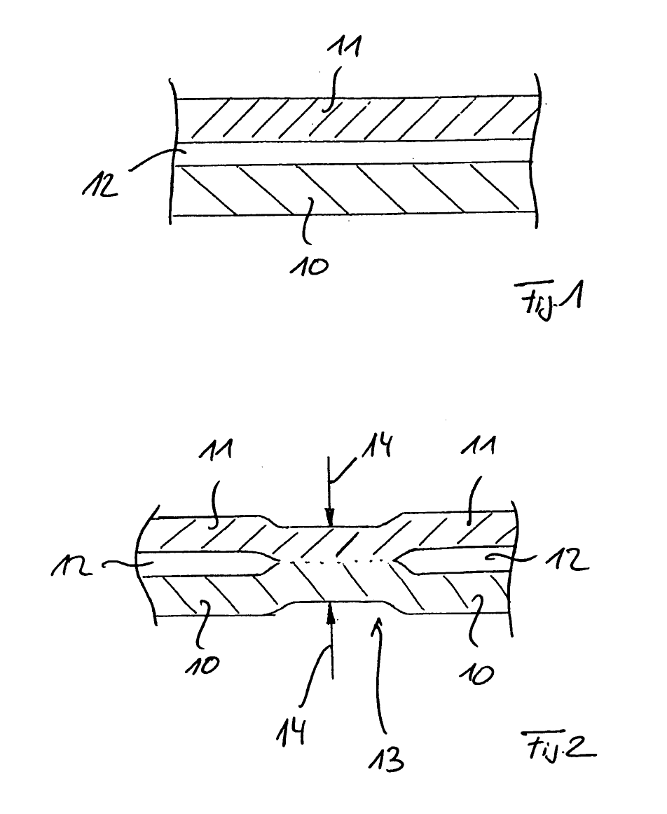

### DETAILED DESCRIPTION

The present invention relates to the joining over a flat surface area of relatively thin-walled components, which are not inherently stable and are thus susceptible to deformation, by brazing.

Along the lines of the method according to the present invention, at least two relatively thin-walled, as well as not inherently stable components 10 and 11, as well as a brazing foil 12, which is used for joining the two components 10 and 11 using a brazing technique, are prepared. In the case of the relatively thin-walled, not inherently stable components 10 and 11, it is preferably a question of sheet-metal panels.

Before components 10 and 11 are actually joined by brazing, they are aligned relative to one another with brazing foil 12 being interposed therebetween. Once components 10 and 11 are aligned with brazing foil 12 being interposed therebetween, components 10 and 11 to be joined together are fixed in position in their alignment and, in fact by tack welding. Components 10, 11 are fixed in position by tack welding in such a way that they are joined to one another section-by-section at at least one position 13 which is spaced apart from an edge of components 10 and 11 to be joined together. Welding electrodes (not shown) are used for tack welding components 10, 11 at the or each position 13. They exert a pressure in the direction of arrows 14 onto components 10, 11 in the area of positions 13. Components 10 and 11 are joined together by resistance welding at positions 13 without the use of any additional welding material.

As previously explained, the tack welding is carried out at at least one position 13. It is preferably carried out as spot welding at a plurality of positions 13 which are all spaced apart from the edges of components 10 and 11.

During the process of tack welding components 10 and 11 to fix the same in position, either localized displacement of the brazing solder of brazing foil 12 occurs at the or each position 13 of the tack weld, or localized surface-alloying of the brazing solder into the tack weld connection between components 10 and 11 occurs at positions 13 of the tack weld.

Once components 10 and 11 to be joined together are fixed in position in the manner described above, they are joined by brazing in that the components which are fixed in position relative to one another, including brazing foil 12 disposed therebetween, are heated to a brazing temperature that is above the lower melting point, respectively the solidus point of the brazing foil. The joining by brazing takes place either under vacuum or in an inert gas atmosphere.

1-6. (canceled)

7. A method for joining components over a flat surface area using a brazing technique, the method comprising the steps of:
aligning a first component and a second component with one of a brazing foil or a brazing solder interposed between the first component and the second component;
tack welding the first component and the second component together in at least one position that is spaced apart from an edge of the first component and an edge of the second component so as to form at least one tack weld and fix the first component and the second component in position relation to one another; and
joining the fixed-in-position first and second components by brazing.

8. The method as recited in claim 7 wherein the tack welding step includes displacing the one of the brazing foil or the brazing solder at the at least one position of the at least one tack weld.

9. The method as recited in claim 7 wherein the tack welding step includes surface-alloying the one of the brazing foil or the brazing solder into the tack weld at the at least one position of the at least one tack weld.

10. The method as recited in claim 7 wherein the tack welding step includes tack welding the first component and the second component together at a plurality of positions that are spaced apart from edges of the first component and edges of the second component so as to form a plurality of tack welds.

11. The method as recited in claim 7 wherein the tack welding step is carried out by resistance welding without the use of any additional welding material.

12. The method as recited claim 7 wherein the joining step is carried out by heating the first component and the second component.

13. The method as recited claim 7 wherein the first component and the second components are thin-walled components.

14. The method as recited claim 7 wherein the first component and the second components are sheet-metal panels.
